(19) United States
(12) Patent Application Publication
(10) Pub. No.: US 2015/0115511 A1
(43) Pub. Date: Apr. 30, 2015

(54) COOLING ELEMENT AND METHOD FOR MANUFACTURING A COOLING ELEMENT

(71) Applicant: OUTOTEC OYJ, Espoo (FI)

(72) Inventors: Mari Lindgren, Pori (FI); Peter Björklund, Espoo (FI); Mikael Jåfs, Espoo (FI); Lauri P. Pesonen, Helsinki (FI)

(73) Assignee: OUTOTEC OYJ, Espoo (FI)

(21) Appl. No.: 14/361,066

(22) PCT Filed: Nov. 30, 2012
(86) PCT No.: PCT/FI2012/051192

§ 371 Date: May 28, 2014

(30) Foreign Application Priority Data
Nov. 30, 2011 (FI) 20116202

(51) Int. Cl. F27D 9/00; F28F 21/08; B23K 26/30; C23C 26/00; B23K 26/00; C22C 19/05

(52) U.S. Cl. CPC F27D 9/00; B23K 26/0066; C22C 19/051; B23K 26/422; C23C 26/00; F28F 21/089; F27D 2009/0056
USPC 266/241; 266/270; 427/597; 165/185; 165/47

(57) ABSTRACT

The invention relates to a cooling element for a pyrometallurgical furnace such as for a flash smelting furnace or for a flash converting furnace or for a suspension smelting furnace. The invention relates also to a method for manufacturing a cooling element for a pyrometallurgical furnace such as for a flash smelting furnace or for a flash converting furnace or for a suspension smelting furnace. The cooling element (2) has a fire surface (2) to be in contact with an interior of the metallurgical furnace. The cooling element comprises a base element (4) containing copper and a coating (5) at least partly covering the base element (4). The coating (4) forms the fire surface (2) of the cooling element (1). The coating (5) is at least partly applied by a laser coating process such as laser deposition, and the coating (5) contains a Ni based alloy.

### FIELD OF THE INVENTION

The invention relates to a cooling element for a pyrometallurgical furnace such as for a flash smelting furnace or for a flash converting furnace or for a suspension smelting furnace as defined in the preamble of independent claim 1, wherein the cooling element has a fire surface to be in contact with an interior of the metallurgical furnace wherein the cooling element comprises a base element containing copper and a coating at least partly covering the base element, and wherein the coating forms at least partly the fire surface of the cooling element.

The invention relates also to a method for manufacturing a cooling element for a furnace such as for a flash smelting furnace or for a flash converting furnace or for a suspension smelting furnace as defined in the preamble on independent claim 10, wherein the cooling element comprising a base element containing copper and a fire surface to be in contact with an interior of the metallurgical furnace, wherein the method comprising a providing step for providing a base element containing copper and a coating step for coating the base element with a coating that at least partly covers the base element so that the coating forms the fire surface of the cooling element.

Cooling elements comprising a base element of copper and coating at least partly covering the base element are known in the art.

Publication WO 2004/042195 presents a method for preparing a coating for pyrometallurgical furnace cooling elements. The purpose of the invention is to attain a method for the formation of a coating on a metallurgical furnace cooling element in a simple way. This is done by using thermal spraying technology. Said cooling element comprises mainly a frame section of copper and a channel network made in the frame section for the circulation of the cooling medium. A corrosion-resistant coating is arranged on at least part of the element surface, the coating forms a metallurgical bond together with the element and that the basic structure of the coating forms of substantially iron and/or nickel based materials.

Publication FI 120047 B presents a method for coating a copper element. In this method the copper element is coated by means of an arc welding method in one coating step with a dense, wear resistant, corrosion resistant, and/or high temperature resistant coating having a thickness in the range of more than 1 mm.

Publication WO 2008/037836 presents a method for coating a cooling element mainly made of copper, provided with water cooling pipes and used particularly in connection with metallurgic furnaces or the like, wherein the cooling element includes a fire surface that is in contact with molten metal, suspension or process gas; side surfaces and an outer surface, so that at least part of the fire surface is coated by a corrosion resistant coating.

### OBJECTIVE OF THE INVENTION

An object of the invention is to provide a cooling element comprising a base element of copper and coating at least partly covering the base element with a good metallurgical bond between the coating and the cooling element.

Another object of the invention is to provide a method for manufacturing a cooling element comprising a base element of copper and coating at least partly covering the base element and having a good metallurgical bond between the coating and the cooling element.

### SHORT DESCRIPTION OF THE INVENTION

The cooling element of the invention is characterized by the definitions of independent claim 1.

Preferred embodiments of the cooling element are defined in the dependent claims 2 to 9.

The method for manufacturing a cooling element is correspondingly characterized by the definitions of independent claim 10.

Preferred embodiments of the method are defined in the dependent claims 11 to 19.

The invention is based on the coating being at least partly applied by a laser coating process such as laser deposition and on the coating containing a nickel, Ni, based alloy.

The coating may contain in percentages of mass: Iron, Fe, 0.1 to 15%; Nickel, Ni, 50 to 65%; Chromium, Cr, 1 to 30%; Molybdenum, Mo, 5 to 30%; Copper, Cu, less than 2%; Manganese, Mn, less than 3%; Cobalt, and Co, less than 3%.

The good metallurgical bond achieved by laser depositing the coating improves heat transfer between the copper of the base element and the coating minimizes the surface temperature of the cooling element and minimizes thermal expansion differences between the copper of the base element and the coating. The coating does not negatively affect the cooling capacity of the cooling element.

The surface of the coating is preferably smooth and it provides for protection against corrosion and erosion of the cooling element and as a consequence a smooth surface of the cooling element can remain smooth and therefore the cooling element has a good non-sticking surface property for a much longer time compared to a cooling element in which the copper of the base element forms the fire surface of the cooling element.

A manufacturing process for manufacturing a cooling element according to the invention may involve the following steps: rough machining of the surface of the base element to be coated, the actual coating process, and machining of the surface to desired smoothness and dimensional tolerances.

Several advantages are achieved by a cooling element according to the invention.

In laser coating, the coating material, powder or wire, is applied on the surface of the base material through a melting process. In laser coating the coating material is injected with a carrier gas to the laser beam traversing on a surface of the material or component to be coated. The coating material absorbs energy from the laser beam, starts heating and melting in-flight and deposits on the surface of the base material. Part of the energy is also absorbed by the surface causing controlled melting of a thin layer of the base material. This ensures the formation of a real metallurgical bonding between the coating and the base material.

In laser coating a melt pool of the coating material is formed which in turn results in coating without porosity.

Because heating is concentrated on a very thin surface layer of the base material, the mixing between the two materials (coating and base material) i.e. dilution, is minimal. This ensures that the properties of the coating material is utilized most effectively and the fire surface will obtain the characteristics of a nickel-based alloy, not the characteristics of a nickel-copper-alloy.

Laser coating makes it possible to achieve a coating being sufficiently thick.

Because the cooling rate of the coating is very rapid, unwanted changes in the microstructure of the coating will not occur. Additionally very fine microstructure is formed which is beneficial for corrosion and wear properties.

The laser coating process can be automated, which leads to an uniform quality of the coating.

The coating provides additionally for protection against wet corrosion i.e. corrosion due to condensing of acid on the cool surface of the cooling element and provides for protection for the base element of copper against impurities harmful for the base element of copper.

Because the coating is harder that copper, the coating will also protect against erosion.

The coating will provide for a slippery fire surface, because the surface will be smooth, which hinders excrescences from adhering to the fire surface.

The surface smoothness of the coating will remain smooth for a much longer time compared to a smooth copper surface, due to the lower rate of corrosion and erosion. This increases the non-sticking surface property.

In a preferred embodiment of the invention, the cooling element is arranged in an outlet for discharging melt such as molten metal from a pyrometallurgical furnace such as in an outlet for discharging melt such as molten metal from a flash smelting furnace or from a flash converting furnace.

In a preferred embodiment of the invention, the cooling element is arranged in a chamber for holding molten metal of the pyrometallurgical furnace such as in a lower furnace of a flash smelting furnace or in a lower furnace of a flash converting furnace.

In a preferred embodiment of the invention, the cooling element is arranged in a chamber for gas and/or for suspension in a pyrometallurgical furnace such as in a reaction shaft or in an uptake shaft of a flash smelting furnace, or in a reaction shaft or in an uptake shaft of a flash converting furnace, or in a reaction shaft or in an uptake shaft of a suspension smelting furnace.

### LIST OF FIGURES

In the following the invention will described in more detail by referring to the figures, of which

FIG. 1 shows a detail view of a part of a pyrometallurgical furnace provided with cooling element according to a preferred embodiment of the invention, and

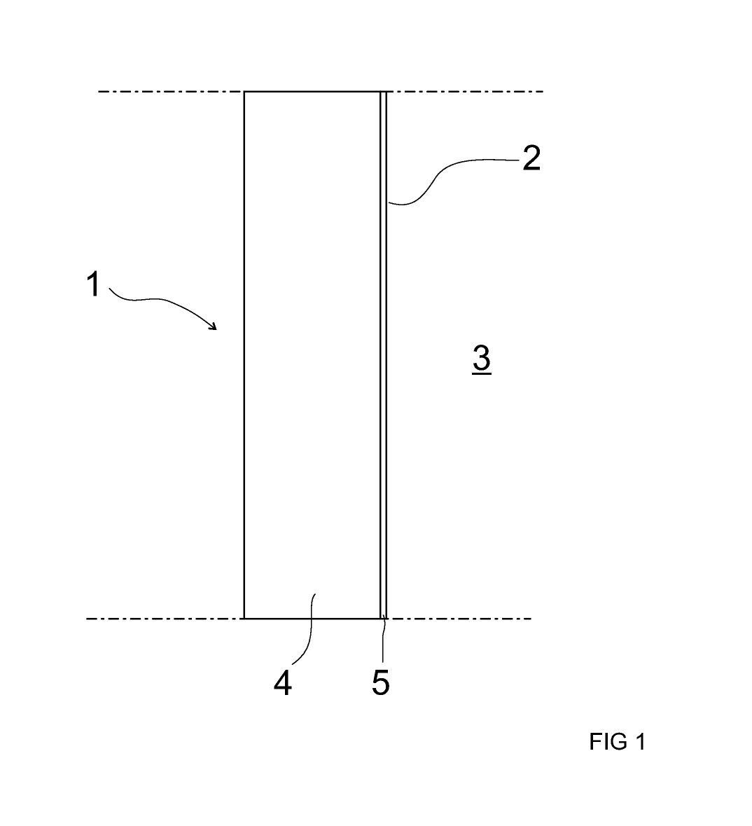

FIG. 2 is a principle view of a suspension smelting furnace.

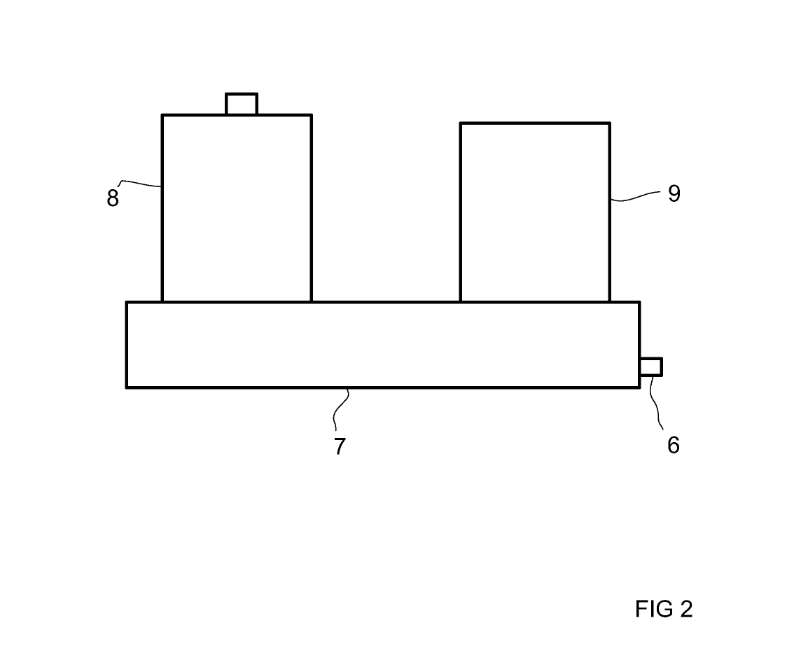

### DETAILED DESCRIPTION OF THE INVENTION

The invention relates to a cooling element 1 for a pyrometallurgical furnace (not marked with a reference number) such as for a flash smelting furnace or for a flash converting furnace or for a suspension smelting furnace.

The cooling element has a fire surface 2 to be in contact with an interior 3 of the metallurgical furnace.

The definition “interior” includes also tap holes and tap openings of a pyrometallurgical furnace.

The cooling element comprises a base element 4 containing copper and/or copper alloy and a coating 5 at least partly covering the base element.

The coating 5 forms at least partly the fire surface 2 of the cooling element 1.

The coating 5 being at least partly applied by a laser coating process such as laser deposition. The coating 5 contains a nickel based alloy i.e. a Ni based alloy.

The coating 5 may contain in mass percentages:

Iron, Fe: 0.1 to 15%;

Nickel, Ni: 50 to 65%;

Chromium, Cr: 1 to 30%;

Molybdenum, Mo: 5 to 30%;

Copper, Cu: less than 2%;

Manganese, Mn less than 3%; and

Cobalt, Co: less than 3%.

Hastelloy® (by Haynes International, Inc.) or Inconel® (by Special Metals Corporation) may be used as coating materials.

In a preferred embodiment of the cooling element 1 the thickness of the coating is in the range of 1 to 5 mm.

In a preferred embodiment of the cooling element the coating covers the fire surface of the cooling element substantially completely.

In a preferred embodiment of the cooling element, the coating 5 forms the fire surface 2 of the cooling element 1 substantially completely.

In a preferred embodiment of the cooling element the coating forms the fire surface of the cooling element and in that the coating extends beyond the fire surface of the cooling element to other parts of the base element such as the sides of the base element.

In a preferred embodiment of the invention, the cooling element is arranged in an outlet 6 for discharging melt such as molten metal from a pyrometallurgical furnace such as in an outlet for discharging melt such as molten metal from a flash smelting furnace or from a flash converting furnace or from a suspension smelting furnace.

In a preferred embodiment of the invention, the cooling element is arranged in a chamber for holding molten metal of the pyrometallurgical furnace such as in a lower furnace of a flash smelting furnace, or in a lower furnace of a flash converting furnace, or in a lower furnace 7 of a suspension smelting furnace.

In a preferred embodiment of the invention, the cooling element is arranged in a chamber for gas and/or for suspension in a pyrometallurgical furnace such as in a reaction shaft or in an uptake shaft of a flash smelting furnace, or in a reaction shaft or in an uptake shaft of a flash converting furnace, or in reaction shaft 8 or in an uptake shaft 9 of a suspension smelting furnace.

The invention relates also to a method for manufacturing a cooling element for a pyrometallurgical furnace such as for a flash smelting furnace or for a flash converting furnace or for a suspension smelting furnace, wherein the cooling element 1 comprising a base element 4 containing copper and a fire surface 2 to be in contact with an interior of the metallurgical furnace.

The method comprises a providing step for providing a base element 4 containing copper.

The method comprises additionally a coating step for coating the base element 4 with a coating 5 that at least partly covers the base element 4 so that the coating 4 forms the fire surface 2 of the cooling element 1.

In the method the coating 5 is applied on the base element 4 in the coating step at least partly by a laser coating process such as laser deposition.

In the method the coating 5 applied on the base element 4 in the coating step contains a Ni based alloy.

In a preferred embodiment of the method a coating 5 is applied in the coating step containing in mass percentages: Iron, Fe, 0.1 to 15%; Nickel, Ni, 50 to 65%, Chromium, Cr, 1 to 30%; Molybdenum, Mo, 5 to 30%; Copper, Cu, less than 2%; Manganese, Mn, less than 3%; and Cobalt, Co, less than 3%.

In a preferred embodiment of the method a coating 5 is applied in the coating step having a thickness in the range of 1 to 5 mm.

In a preferred embodiment of the method a coating 5 is applied in the coating step that forms the fire surface 2 of the cooling element 1 substantially completely.

In a preferred embodiment of the method a coating 5 is applied in the coating step that forms the fire surface 2 of the cooling element 1 and that extends beyond the fire surface 2 of the cooling element 1 to other parts of the base element such as sides of the base element.

A preferred embodiment of the method includes a machining step for machining at least partly the parts of the cooling element 1 to be coated by the coating 5 in the coating step prior the coating step.

A preferred embodiment of the method includes a machining step for machining the coating 5 to desired smoothness and/or dimensional tolerances after the coating step.

A preferred embodiment of the method comprises an arranging step for arranging the cooling element 1 in an outlet for discharging melt such as molten metal from a pyrometallurgical furnace such as in an outlet 6 for discharging melt such as molten metal from a flash smelting furnace or from a flash converting furnace or from a suspension smelting furnace.

A preferred embodiment of the method comprises an arranging step for arranging the cooling element 1 in a chamber for holding molten metal of the pyrometallurgical furnace such as in a lower furnace of a flash smelting furnace or in a lower furnace of a flash converting furnace or in a lower furnace 7 of a suspension smelting furnace.

A preferred embodiment of the method comprises an arranging step for arranging the cooling element 1 in a chamber for gas and/or for suspension in a pyrometallurgical furnace such as in a reaction shaft or in an uptake shaft of a flash smelting furnace or in a reaction shaft or in an uptake shaft of a flash converting furnace or in a reaction shaft 8 or in an uptake shaft 9 of a suspension smelting furnace.

It is apparent to a person skilled in the art that as technology advanced, the basic idea of the invention can be implemented in various ways. The invention and its embodiments are therefore not restricted to the above examples, but they may vary within the scope of the claims.

1. Cooling element for a pyrometallurgical furnace such as for a flash smelting furnace or for a flash converting furnace or for a suspension smelting furnace,
wherein a cooling element has a fire surface to be in contact with an interior of the metallurgical furnace,
wherein the cooling element comprises a base element containing copper and a coating at least partly covering the base element, and
wherein the coating forms the fire surface of the cooling element,
characterized
by the coating being at least partly applied by a laser coating process such as laser deposition, and
by the coating containing a Ni based alloy.

2. The cooling element according to claim 1, characterized in that by the coating containing in mass percentages
Fe: 0.1 to 15%,
Ni: 50 to 65%,
Cr: 1 to 30%,
Mo: 5 to 30%,
Cu: less than 2%,
Mn: less than 3%, and
Co: less than 3%.

3. The cooling element according to claim 1, characterized by the thickness of the coating is in the range of 1 to 5 mm.

4. The cooling element according to claim 1, characterized by the coating covers the fire surface of the cooling element substantially completely.

5. The cooling element according to claim 1, characterized by the coating forms the fire surface of the cooling element substantially completely.

6. The cooling element according to claim 1, characterized by the coating forms the fire surface of the cooling element and in that the coating extends beyond the fire surface of the cooling element to other parts of the base element such as sides of the base element.

7. The cooling element according to claim 1, characterized by the cooling element being arranged in an outlet for discharging melt such as molten metal from a pyrometallurgical furnace such as in an outlet for discharging melt such as molten metal from a flash smelting furnace or from a flash converting furnace or from a suspension smelting furnace.

8. The cooling element according to claim 1, characterized by the cooling element being arranged in a chamber for holding molten metal of the pyrometallurgical furnace such as in a lower furnace of a flash smelting furnace or in a lower furnace of a flash converting furnace or in a lower furnace of a suspension smelting furnace.

9. The cooling element according to claim 1, characterized by the cooling element being arranged in a chamber for gas and/or for suspension in a pyrometallurgical furnace such as in a reaction shaft or in an uptake shaft of a flash smelting furnace or in a reaction shaft or in an uptake shaft of a flash converting furnace or in a reaction shaft or in an uptake shaft of a suspension smelting furnace.

10. Method for manufacturing a cooling element for a pyrometallurgical furnace such as for a flash smelting furnace or for a flash converting furnace or for a suspension smelting furnace, wherein a cooling element comprising a base element containing copper and a fire surface to be in contact with an interior of the metallurgical furnace, wherein the method comprising
a providing step for providing a base element containing copper, and
a coating step for coating the base element with a coating that at least partly covers the base element so that the coating forms the fire surface of the cooling element,
characterized
by applying the coating in the coating step at least partly by a laser coating process such as laser deposition, and
by applying in the coating step a coating containing a Ni based alloy.

11. The method according to claim 10, characterized by applying in the coating step a coating containing in mass percentages
Fe: 0.1 to 15%,
Ni: 50 to 65%,
Cr: 1 to 30%,
Mo: 5 to 30%,
Cu: less than 2%,
Mn: less than 3%, and
Co: less than 3%.

12. The method according to claim 10, characterized by applying in the coating step a coating having a thickness in the range of 1 to 5 mm.

13. The method according to claim 10, characterized by applying in the coating step a coating that forms the fire surface of the cooling element substantially completely.

14. The method according to claim 10, characterized by applying in the coating step a coating that forms the fire surface of the cooling element and that extends beyond the fire surface of the cooling element to other parts of the base element such as sides of the base element.

15. The method according to claim 10, characterized by a machining step for machining at least partly the parts of the cooling element to be coated by the coating in the coating step prior the coating step.

16. The method according to claim 10, characterized by a machining step for machining the coating to a selected smoothness and/or dimensional tolerances after the coating step.

17. The method according to claim 10, characterized by an arranging step for arranging the cooling element in an outlet for discharging melt such as molten metal from a pyrometallurgical furnace such as in an outlet for discharging melt such as molten metal from a flash smelting furnace or from a flash converting furnace or from a suspension smelting furnace.

18. The method according to claim 10, characterized by an arranging step for arranging the cooling element in a chamber for holding molten metal of the pyrometallurgical furnace such as in a lower furnace of a flash smelting furnace, or in a lower furnace of a flash converting furnace, or in a lower furnace of a suspension smelting furnace.

19. The method according to claim 10, characterized by an arranging step for arranging the cooling element in a chamber for gas and/or for suspension in a pyrometallurgical furnace such as in a reaction shaft or in an uptake shaft of a flash smelting furnace, or in a reaction shaft or in an uptake shaft of a flash converting furnace, or in a reaction shaft or in an uptake shaft of a suspension smelting furnace.
